(19) United States
(12) Patent Application Publication
(10) Pub. No.: US 2005/0136499 A1
(43) Pub. Date: Jun. 23, 2005

(54) Control plasma for thrombin activity tests

(75) Inventor: Thilo Henckel, Wetter (DE)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: DADE BEHRING MARBURG GmbH

(21) Appl. No.: 11/013,801

(22) Filed: Dec. 17, 2004

(30) Foreign Application Priority Data
Dec. 19, 2003 (DE) 103 60 628.9

(51) Int. Cl. A01N 1/02

(52) U.S. Cl. 435/13; 435/2

(57) ABSTRACT

Delipidized plasma preparations which possess prothrombin concentrations which are set in a defined manner and which are lower or higher than those in normal human plasma are suitable for calibrating, standardizing and controlling thrombin activity tests and thrombin generation tests such as ETP tests. The plasma preparations are produced using a prothrombin-deficient plasma, which is obtained from normal plasma by means of immunoadsorption, for example, and can additionally comprise buffering substances, proteinase inhibitors, anticoagulants, stabilizers and/or other auxiliary substances and additives which are customary when preparing plasmas.

The present invention relates to reference plasma products, in particular reference plasma products of defined prothrombin concentration and thrombin activity, which can be used, in particular, for controlling and calibrating thrombin activity tests and thrombin generation tests. They are preferably used in methods for determining the endogenous thrombin potential (ETP tests).

An ETP test within the meaning of the present invention is a global coagulation test which can be used for determining the formation and inhibition of thrombin. The endogenous thrombin potential (ETP) is understood as meaning the ability (potential) which is inherent (endogenous) in a sample, i.e. which is plasma-inherent in the case of plasma samples, to form and inhibit enzymically active, free thrombin.

A parameter which is preferably determined for quantifying the endogenous thrombin potential, and which is also termed the “endogenous thrombin potential” in the literature, is the time/concentration integral or the area under the thrombin formation curve (see EP 0 420 332 B1). This parameter is a measure of the quantity and activity of endogenous thrombin which was present since a time t=0 in a sample of coagulating blood or plasma.

Determination of the endogenous thrombin potential is an important prerequisite for, for example, carrying out an effective treatment with antithrombotic agents in humans or animals and for reliably monitoring this over the period of the treatment. An ETP test can be used universally for all antithrombotic agents and is consequently superior to other coagulation tests known from the prior art, such as determining the coagulation time using tissue thromboplastin (prothrombin time=PT) or determining the coagulation time using contact activators and phospholipids (activated partial thromboplastin time=APTT). Thus, the PT method is sensitive to oral anticoagulation but insensitive to heparin. While the APTT method is sensitive to heparin and oral anticoagulation, it is insensitive, or virtually insensitive, to low molecular weight heparins or to dermatan sulfate. Furthermore, the ETP covers thrombogenic risk factors, such as the increase in the risk of a thrombosis resulting from oral contraception (ingestion of the “pill”), smoking or pregnancy, which are not covered in conventional global tests.

In ETP tests, the measurements are carried out using a photometer (e.g. measurement of the optical density) or a fluorimeter, for example. Suitable automated coagulation analyzers can also be used for this purpose. The measured values which are obtained using the respective instruments are initially absolute values without any reference system and are therefore also described as being raw values. They are instrument-specific, reagent-specific and test-specific and cannot therefore be compared directly with each other and can consequently not be assigned directly to a particular physiological state, either. An ETP test has not thus far been standardized, with this also being due to the nonexistence of suitable calibration reagents.

The significance, as compared with the prior art as well, the implementation and the analysis of the ETP test are described, for example, in EP 0 420 332 B1 and EP 0 802 986 B1 and the literature which is cited therein.

In order to be able to integrate the absolute measurement results from enzymic activity tests into a reference system, there is a need for calibration and/or control substances which have known defined values, that is a known enzyme concentration and/or enzymic activity. It is only in this way that it becomes possible to compare and standardize measurement results. Control substances are also necessary for indicating to the user whether the measurement system and the measurement results are correct or not. This is of particular importance for monitoring the correctness and reliability of the course of a test in the pathological sample field, for example in connection with treating patients with antithrombotic agents.

Such control substances, and also control plasmas, are known in the case of the PT and APTT methods which are known from the prior art. Thus, WO 01/07921 A2 describes a plasma mixture which, in addition to primate plasma, which is the main constituent, also contains nonprimate plasma and stabilizers such as buffering substances and fibrinolysis inhibitors. WO 95/12127 claims lyophilized plasma samples for calibrating the PT method which samples have specific values for thromboplastin such as IRP (international-reference preparation). WO 00/02054 describes plasmas which comprise an abnormal plasma, i.e. a mixture of primate plasma and nonprimate plasma, and an anticoagulant. Finally, EP 0 482 088 B1 relates to stable control plasmas which, in addition to nonprimate plasma contain effective contents of buffering substances, protease inhibitors and stabilizing carbohydrates.

As already explained above, no such control substances, reference substances or calibration substances have thus far existed for thrombin activity tests and thrombin generation tests, such as ETP tests. The user has to make do with establishing a normal value by measuring a normal plasma or normal plasma pool. Sample values which have been obtained are then related to this normal value by means of a linear rule of proportion method and given, for example, in % of the norm, units or nmol×min (cf., for example, description of the ETP test in EP 0 420 332 B1).

The object of the present invention was therefore to provide reference substances, or control or calibration substances, which can be used, in particular, for standardizing, calibrating, and checking the correctness of, thrombin activity tests and thrombin generation tests, preferably an ETP test.

This object is achieved by means of the subject-matter and methods which are described in the claims, in particular by means of the plasma products according to the invention.

Plasma products according to the invention contain one or more human or animal prothrombin deficient plasmas (factor II-deficient plasmas) or mixtures thereof. In addition, they can also contain normal human plasma or animal plasma. The prothrombin-deficient plasmas, the normal plasmas and/or the plasma product according to the invention can preferably be delipidized. Delipidized plasmas can be lyophilized and will therefore keep for very long periods without any loss of activity.

The plasma products according to the invention can preferably be defibrinated. In order to avoid fibrin clots during the continuous measurement of thrombin formation and thrombin inhibition, preferably in chromogenic thrombin generation tests, either inhibitors of fibrin aggregation or fibrin polymerization, what are termed clot inhibitors, can be added to the reagent mixture or the fibrin can be removed from the plasma beforehand. Examples of suitable clot inhibitors are Pefabloc®FG H-Gly-Pro-Arg-Pro-OH-AcOH (Pentapharm Ltd., Switzerland) or peptide amides, as are described in EP 0 456 152-B1.

The plasma can be defibrinated by means of a variety of methods known to the expert, for example by means of adding snake venoms such as batroxobin, by means of heat, by means of precipitation or by means of immuno-affinity chromatography.

Defibrinating the plasma products according to the invention makes it possible, in a general manner, to use the calibration plasmas both in tests employing clot inhibitor and tests without clot inhibitor.

In a preferred embodiment, plasma products of human origin having different and defined prothrombin concentrations (prothrombin=factor II=FII) or thrombin activities (thrombin=factor IIa=FIIa) are prepared. These different thrombin activities in the plasma are produced, or set in a defined manner, by means of employing different, defined concentrations of prothrombin in the plasma. For this, the prothrombin concentration, and thus the thrombin activity, of the plasma can be set at low through to very high values, i.e. the prothrombin concentration or thrombin activity in the plasma product according to the invention can be either below or above the corresponding values of a normal plasma or of a normal plasma pool. Quantitatively determining the endogenous thrombin potential of these defined plasma products produces measured values (ETP raw values) which are compared with the prothrombin concentration or thrombin activity of the plasma. This thereby results in a calibration curve on which unknown samples or their measured values can be determined with the aid of a suitable mathematical algorithm.

In exactly the same way, individual plasmas containing prothrombin concentrations or thrombin activities which are low, normal or above the normal value can be used as control plasmas for checking the correctness of the measurement system.

For reasons of simplification, the plasma products according to the invention are described, as a whole and irrespective of their possible use, as being control plasmas.

Consequently, the control plasmas according to the invention can be used, for example, for standardizing and calibrating enzymic activity tests which determine thrombin activity. This makes it possible to quantify the prothrombin concentration and/or thrombin activity of an unknown sample, which concentration and/or activity can be below or above the normal prothrombin concentration and/or thrombin activity.

This thereby results, in particular, in the following areas of application for said control plasmas: calibration, standardization and/or control of thrombin generation tests such as ETP tests, of thrombin activity tests, of prothrombin tests or of enzymic tests in which the thrombin activity or the thrombin concentration is determined by way of activating prothrombin. In addition, the control plasmas are suitable for simulating pathological coagulation states. Hypercoagulatory or else hypocoagulatory states, as caused by altered prothrombin formation or thrombin formation, can be portrayed.

Calibration curves or reference curves can be constructed by using a calibration set which comprises at least 2 control plasmas which are in accordance with the invention and contain different concentrations of FII or by diluting a highly concentrated control plasma with a suitable dilution medium:

1. Using a Calibration Plasma Set which Comprises Several Control Plasmas of Different FII Concentrations:

The endogenous thrombin potentials of a particular number of control plasmas containing different concentrations of FII are measured and assigned to the corresponding prothrombin concentrations in the respective control plasmas. There is a directly proportional, linear connection between the measured values which are determined and the prothrombin concentrations of the control plasmas. The prothrombin concentrations or else the prothrombin activities of unknown samples can be calculated using a suitable algorithm.

2. Using a Calibration Plasma Set which Comprises a Control Plasma of High FII Concentration and a Dilution Medium:

A control plasma of high prothrombin concentration is preferably diluted serially with FII-deficient plasma. Ideally, the prothrombin concentration in the control plasma to be diluted should exceed the maximum sample values which are to be expected. A concentration which is about three times the normal should be sufficient even to be able to determine hypercoagulable samples below the maximum value of the reference curve. The endogenous thrombin potentials are determined quantitatively and assigned to the corresponding concentrations of the individual dilution steps. There is a directly proportional, linear connection between the measured values which are determined and the prothrombin concentrations of the different dilution steps. The prothrombin concentrations or else the prothrombin activities of unknown samples can be calculated using a suitable algorithm.

The method of producing a control plasma according to the invention is described in more detail below:
a) Producing control plasmas having subnormal to normal thrombin activity:
   A normal plasma pool and/or individual normal plasmas is/are prepared by selecting blood donors (human or animal) who/which are evidently healthy. The normal plasma pool or the normal plasma is freed, or to a large extent freed, from prothrombin by adsorption, for example using prothrombin-specific monoclonal and/or polyclonal antibodies, resulting in what is termed an FII-deficient plasma being obtained. One of the following methods A) or B) is used to establish particular FII concentrations and activities in this FII-deficient plasma.
   A) Adding defined quantities of a normal plasma or normal plasma pool to FII-deficient plasma, thereby making it possible to achieve FII concentrations of up to what is almost the concentration of FII in healthy blood donors.
   B) Adding pure prothrombin or prothrombin concentrate to FII-deficient plasma.
b) Producing control plasmas having thrombin activities which are in excess of normal values:
   Purified FII or a prothrombin concentrate is used to establish a supernormal FII concentration in a normal plasma pool, a normal plasma or an FII-deficient plasma, thereby preferably achieving FII concentrations of more than 1.4 μM or an FIIa activity of more than 1 U/ml. 1 U is the activity of FIIa which is required in order to achieve a normal coagulation time (thromboplastin time or Quick value) of 70-130% of the norm. An FII concentration of 90 μg per ml of plasma, or 1.4 μM, or 1 unit of FIIa activity per ml of plasma, corresponds to a normal FII value.
      Human, animal or recombinantly prepared prothrombin can be used for the control plasmas according to the invention. Recombinantly prepared human prothrombin is particularly preferred.

The control plasmas according to the invention can be used fresh. If a relatively long period of storage extending over several weeks is desired, the control plasmas should be stored deep-frozen or lyophilized.

By adding suitable stabilizers (e.g. hepes or tris; cf. WO 01/07921 A2, page 8), the control plasmas can be made to be durable for a long period. The control plasmas should preferably be delipidized before being lyophilized or being stored in the frozen state. This has the advantage that these control plasmas can be used in chromogenic detection methods, e.g. a chromogenic ETP test.

Delipidizing the plasma products according to the invention (e.g. by means of adsorption to lipophilic substances or suspension by centrifugation or clarification by dissolution in organic substances which are not water-soluble) is advantageous in order to prevent precipitation or opacification by lipid colloids after the lyophilized or thawed products have been reconstituted. Such lipid colloids can, for example, interfere severely with the photometric measurement of the thrombin formation kinetics (cf., e.g., EP 0 420 332-B1).

Particularly by means of delipidizing and subsequently lyophilizing, it is possible to produce control plasmas of defined prothrombin concentration, and consequently of defined thrombin activity, which can be stored for a very long time, even for a period of more than 12 months.

It is also possible to dispense with the delipidization step. However, lipid colloids and denatured protein which have been formed after reconstitution should then be removed from the products, e.g. by means of centrifugation, adsorption or filtration.

The control plasmas according to the invention can contain anticoagulants such as sodium citrate or EDTA; buffering substances such as hepes or tris; protease inhibitors such as Trasylol® (aprotinin); stabilizers of the coagulation factors such as sugars or sugar alcohols, and/or other auxiliary substances and additives which are customary in preparing plasmas. Other examples of the abovementioned substance classes are known to the skilled person and are described, for example, in WO 01/07921 A2 (in particular on pages 8 and 9 therein), which document is hereby expressly incorporated by reference.

The production of the control plasmas according to the invention is described in detail below with the aid of examples without there being any wish to thereby limit the invention to the scope of the examples. The production methods which are described, and the uses of the control plasmas according to the invention which are specified, likewise form part of the subject matter of the present invention.

### EXAMPLES

### Example 1

### Preparing a Stabilized Plasma Pool

Blood is withdrawn from donors who are obviously healthy. The blood is anticoagulated using a sodium citrate concentration of 0.105 mol/l. In order to obtain the plasma, the samples are centrifuged, without braking, for 20±2 min at 1500×g and +10° C. The centrifugation should have taken place within 4 hours after blood withdrawal. The plasma fractions from each individual donation are mixed to form a pool. This pool is stabilized by adding a 40%-strength hepes (N-[2-hydroxyethyl]piperazine-N′-[2-ethanesulfonic acid]) solution (10 ml/l of plasma) and Trasylol® (10 000 KIE/ml; 2 ml/l of plasma), and subsequently filtered. The pH of the normal plasma pool should be in the normal range, preferably pH 7.3±0.2.

### Example 2

### Preparing Factor II-Deficient Plasma

An aliquot of the normal plasma pool prepared as described in example 1 is pumped through a chromatography column which contains FII-specific monoclonal antibody (Dade Behring Marburg GmbH, Germany) which is bound to CNBr-activated Sepharose. The fractions of the eluate having an FII activity which is <1% of the norm are collected. Any possible deficiency of FVIII (<70% of the norm) is compensated for by adding FVIII concentrate (e.g. Haemate®, Aventis Behring GmbH, Germany). For stabilization, D(−)-mannitol (20 g/l of plasma) is added to the mixture while stirring slowly so as to avoid any foam formation.

### Example 3

### Delipidizing Plasma

The plasma which is to be delipidized is passed through Triton® X-100 which is covalently coupled to Sepharose CI 2 B. In order to prepare Sepharose CI 2 B-coupled Triton® X-100, the glycidyl ether of Triton® X-100 (Roche Applied Science, Germany) is covalently bonded to Sepharose CI 2B (Pharmacia Biotech, Sweden) using the catalytic effect of boron trifluoride ethyl etherate. Triton® X-100-Sepharose binds lipoproteins while other proteins pass through the adsorbent unbound such that a clear, stabilized plasma, which is suitable, for example, for preparing ETP reference plasma, is obtained.

The quantity of plasma which is loaded onto the column depends on the binding capacity of the Triton® X-100-Sepharose. It should not exceed 80% of the theoretical binding capacity.

The Triton® X-100 Sepharose column is equilibrated with 10 mM sodium citrate buffer plus 0.9% sodium chloride, pH 7.4. The plasma pool is loaded on at maximum flow. After the plasma pool has run in completely, the column is then rinsed with >1 gel bed volume of sodium citrate in order to elute all unbound proteins. Fractions are collected after <0.9 of a gel bed volume (plasma+elution buffer) has run in. All the fractions of the flanking regions having a UV absorption (280 nm/1 cm path length) of >0.7 are mixed by pivoting while avoiding the formation of foam.

### Example 4

### Defibrinating Plasma

The method employed here involves defibrinating using Bothrops atrox snake venom (Batroxobin, Dade Behring Marburg GmbH, Germany). Plasma is incubated, at room temperature for 30 min, with a suitable concentration (e.g. from 1:20 to 1:50) of Batroxobin reagent. The plasma is then centrifuged twice (800×g, 15 min) and the supernatant is removed. Finally, the supernatant is then filtered through gauze.

### Example 5

### Producing Control Plasmas According to the Invention (Addition of FII Concentrate to FII-Deficient Plasma)

Any arbitrary prothrombin concentrations and activities can be produced by adding prothrombin to prothrombin-free plasma (FII-deficient plasma). It is also possible to use this method to produce plasma products which exceed the normal FII value.

By way of example, 6 different calibration plasmas, i.e. levels 1 to 6, having the prothrombin concentrations given below, were prepared from delipidized FII-deficient plasma (see example 2) and prothrombin concentrate (prothrombin solution [cat# 20-267, from Milan, CH-1634 La Roche] in 50 mM tris-HCl): Standardizing the prothrombin concentration in FII-deficient plasma:
Level 1: 0 μg prothrombin/ml
Level 2: 18 μg prothrombin/ml
Level 3: 54 μg prothrombin/ml
Level 4: 90 μg prothrombin/ml
Level 5: 126 μg prothrombin/ml
Level 6: 180 μg prothrombin/ml
   The corresponding ratios in which FII-deficient plasma and prothrombin concentrate are mixed depend on the initial concentration of the given prothrombin batch and have to be calculated accordingly. The mixture is stirred carefully, without any formation of foam, until it has been homogeneously blended.

For storage, the control plasmas are lyophilized or deep-frozen (−70° C.).

### Example 6

### Producing Control Plasmas According to the Invention (Addition of FII-Deficient Plasma to Normal Plasma)

By adding FII-deficient plasma (see example 2) to normal plasma (see example 1), it is possible to produce prothrombin concentrations and activities which do not exceed the normal FII value (approx. 1.4 μM FII).

The corresponding ratios in which FII-deficient plasma and normal plasma (NP) are mixed are calculated accordingly. In this connection, the activity of a normal human plasma is defined as being 1 U/ml. 1 U is the activity of FIIa which is required in order to achieve a normal coagulation time (thromboplastin time or Quick value) of 70-130% of the norm. This results in the following activities:

Example

Level 1: 8 parts by volume of FII-deficient plasma+2 parts by volume of NP→0.2 U/ml
Level 2: 6 parts by volume of FII-deficient plasma+4 parts by volume of NP→0.4 U/ml
Level 3: 4 parts by volume of FII-deficient plasma+6 parts by volume of NP→0.6 U/ml
Level 4: 2 parts by volume of FII-deficient plasma+8 parts by volume of NP→0.8 U/ml
Level 5: NP→1.0. U/ml
   The mixture is stirred carefully, without any formation of foam, until it has been homogeneously blended. For storage, the plasmas are lyophilized or deep-frozen (−70° C.)

### Example 7

### Determining the FII Activity

The FII activity or the thrombin activity can be determined, in accordance with the manufacturer's instructions (coagulation factor II-deficient plasma, order No. OSGR, Dade Behring Marburg GmbH, Germany), by means of the prolongation of the prothrombin time (PT) of a sample. For the single factor determination, the PT of a mixture of the FII-deficient plasma and a sample to be determined is measured. The activity of the FII in % of the norm is ascertained by way of a reference curve which is constructed using dilutions of normal plasma pool or standard human plasma (standard human plasma, order No. ORKL; Dade Behring Marburg GmbH, Germany) with this deficient plasma.

### FIGURES

FIGS. 1 to 4 serve to further clarify the invention.

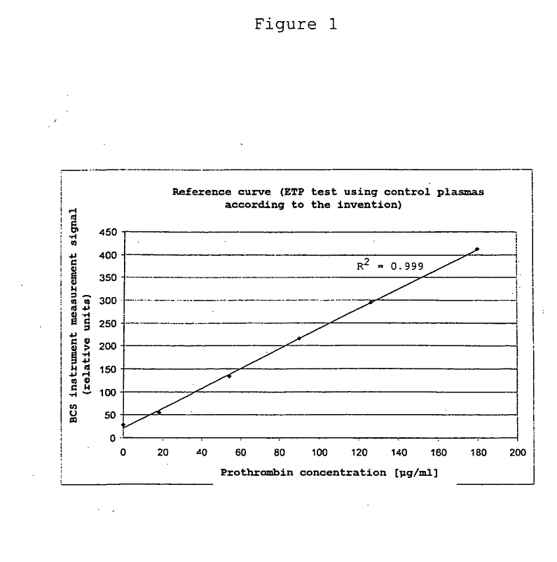

FIGS. 1 and 2 show the correlation of measured raw ETP values (measurement signal of the BCS® instrument) with the prothrombin concentrations of the control plasmas prepared as described in example 5. The prothrombin concentration is given as the actual concentration value (μg of prothrombin/ml) of the relevant control plasma. It is found that the ETP measurement signals are linearly dependent on the prothrombin concentrations, thereby providing a simple possibility of using the control plasmas according to the invention to calibrate, standardize and/or control an ETP test. R²: correlation coefficient of a two-dimensional random quantity. The correlation coefficient can be used to establish whether two properties are related.

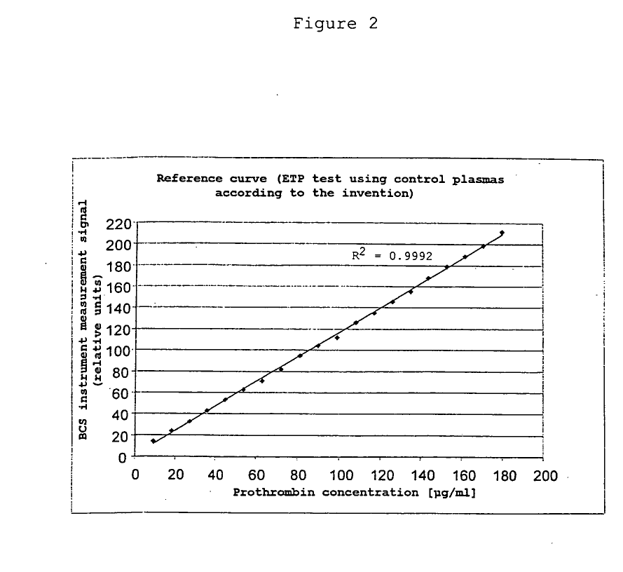

Six control plasmas which contained increasing concentrations of FII and which were stored in lyophilized form were used in the case of FIG. 1 while 20 control plasmas which contained increasing concentrations of FII and which were stored in frozen form were used in the case of FIG. 2.

FIG. 3 shows a representation, which is analogous to FIG. 1, of FII activity (in % of the norm) in dependence on the concentration (μg/ml) of FII in the control plasmas according to the invention. A linear dependence is obtained, thereby providing a very simple possibility of using the control plasmas according to the invention to calibrate, standardize and/or control FII tests or FIIa tests. Since an FII activity test which operates indirectly by way of the coagulation time, by forming a fibrin clot, was used in this case, the linear regression is markedly worse than in the case of the ETP test. The FII activity test is only directly proportional to the concentration of FII in a concentration range of about 30-140 μg of FII/ml. The test was carried out on a BCS® instrument (Dade Behring Marburg GmbH, Germany) in accordance with the manufacturer's instructions using Innovin® (Dade Behring Marburg GmbH, Germany).

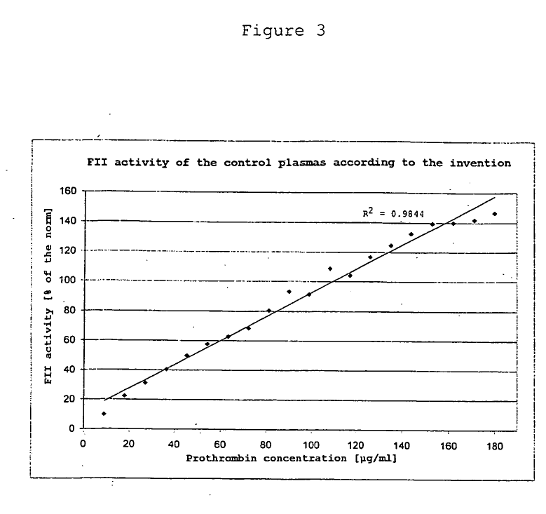

FIG. 4 shows the correlation of measured raw ETP values (measurement signal of the BCS® instrument) with the FII activity of the control plasmas which were prepared as described in example 6. The activity is given as U/ml of the respective control plasma, with a normal plasma pool being defined as being 1 U/ml. The ETP measurement signals are found to be linearly dependent on the FII activity, with this thereby providing a simple possibility of using the control plasmas according to the invention to calibrate and/or control an ETP test.

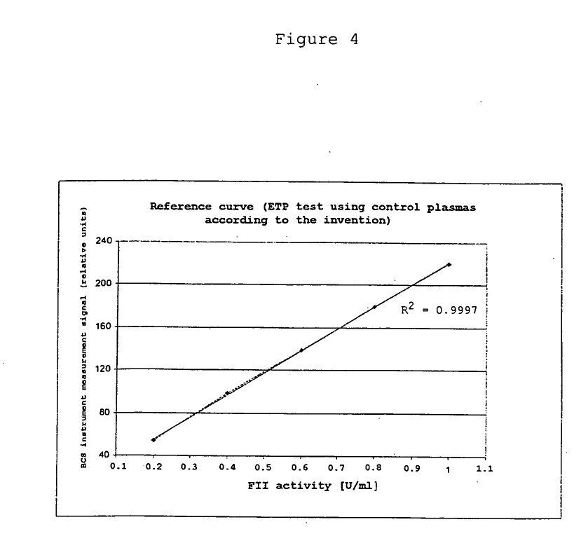

1-23. (canceled)

24. A plasma product comprising a control plasma having an altered prothrombin concentration as compared with normal plasma.

25. The plasma product as in claim 24, wherein the control plasma is animal plasma.

26. The plasma product as in claim 25, wherein the control plasma is human plasma.

27. The plasma produce as in claim 24, wherein the control plasma is a mixture of animal and human plasma.

28. The plasma product as in claim 24, wherein the normal plasma is animal plasma.

29. The plasma product as in claim 28, wherein the normal plasma is human plasma.

30. The plasma product as in claim 24, wherein the prothrombin concentration of the control plasma is higher or lower than that of normal plasma, which is about 1.4 μM.

31. The plasma product as in claim 30, wherein the prothrombin concentration is between 1.5 μM to 5.0 μM.

32. The plasma product as in claim 31, wherein the prothrombin concentration is between 1.6 μM to 4.0 μM.

33. The plasma product as in claim 32, wherein the prothrombin concentration is between 1.7 μM to 3.0 μM.

34. The plasma product as in claim 30, wherein the prothrombin concentration is between 0 μM and 1.3 μM.

35. The plasma product as in claim 34, wherein the prothrombin concentration is between 0.1 μM and 1.2 μM.

36. The plasma product as in claim 35, wherein the prothrombin concentration is between 0.2 μM and 1.0 μM.

37. The plasma product as in claim 24, further comprising at least one of the following: anticoagulant, buffering substance, protease inhibitor, stabilizer, auxiliary substance, and additive.

38. The plasma product as in claim 37, wherein the anticoagulant is selected from sodium citrate, heparin, EDTA, or mixtures thereof.

39. The plasma product as in claim 37, wherein the buffering substance is hepes, tris, or mixtures thereof.

40. The plasma product as in claim 37, wherein the protease inhibitor is aprotinin.

41. The plasma product as in claim 37, wherein the stabilizer is a sugar, sugar alcohol, or mixtures thereof.

42. The plasma product as in claim 41, wherein the stabilizer is mannitol.

43. The plasma product as in claim 24, wherein the control plasma is delipidized.

44. The plasma product as in claim 24, wherein the control plasma is defibrinated.

45. The plasma product as in claim 24, wherein the control plasma is lyophilized.

46. A delipidized human or animal prothrombin-deficient plasma product having a prothrombin concentration that is less than 5% of the corresponding normal plasma.

47. The plasma product as in claim 46, wherein the prothrombin-deficient plasma product has a prothrombin concentration that is less than 1% of the corresponding normal plasma.

48. The plasma product as in claim 46, wherein the prothrombin-deficient plasma product is defibrinated.

49. The plasma product as in claim 46, wherein the plasma product further comprises a mixture of prothrombin-deficient plasmas with normal plasma or prothrombin.

50. The plasma product as in claim 49, wherein the prothrombin is purified prothrombin.

51. The plasma product as in claim 49, wherein the prothrombin is concentrated prothrombin.

52. A method for using prothrombin-deficient plasmas to generate a control plasma comprising:
(a) obtaining normal plasma from human or animal donors;
(b) partially or completely removing the prothrombin from the normal plasma;
(c) adding additional prothrombin or additional normal plasma to the prothrombin-deficient plasma to generate the control plasma with a defined prothrombin concentration or activity.

53. The method as in claim 52, wherein the additional prothrombin is pure prothrombin.

54. The method as in claim 52, wherein the additional prothrombin is concentrated prothrombin.

55. The method as in claim 52, wherein the prothrombin activity in the control plasma is defined by units per milliliter (U/ml), wherein 1.0 U/ml equals the activity of prothrombin required to achieve a normal coagulation time of 70% to 130% of the corresponding normal plasma.

56. The method as in claim 55, wherein the following ratios of prothrombin-deficient plasma to additional normal plasma will generate the stated activity in U/ml:
(a) 8 parts by volume of prothrombin-deficient plasma to 2 parts additional normal plasma will generate a control plasma with an activity of 0.2 U/ml;
(b) 6 parts by volume of prothrombin-deficient plasma to 4 parts additional normal plasma will generate a control plasma with an activity of 0.4 U/ml;
(c) 4 parts by volume of prothrombin-deficient plasma to 6 parts additional normal plasma will generate a control plasma with an activity of 0.6 U/ml;
(d) 2 parts by volume of prothrombin-deficient plasma to 8 parts additional normal plasma will generate a control plasma with an activity of 0.8 U/ml;
(e) 0 parts by volume of prothrombin-deficient plasma mixed with additional normal plasma will generate a control plasma with an activity of 1.0 U/ml.

57. A calibration set, comprising at least two different control plasmas having different prothrombin concentrations.

58. A calibration set as in claim 57, further comprising a dilution medium.

59. A calibration set as in claim 57, wherein the plasmas have prothrombin concentrations between 1.3 μM and 3.9 μM.

60. A calibration set as in claim 58, wherein the dilution medium is a prothrombin-deficient plasma.

61. A method of producing a prothrombin-deficient plasma comprising completely or partially removing the prothrombin from the plasma.

62. The method as in claim 61, wherein the prothrombin is removed using immunoadsorption.

63. The method as in claim 62, wherein the immunoadsorption is accomplished using an antibody.

64. The method as in claim 63, wherein the antibody is a monoclonal antibody.

65. The method as in claim 63, wherein the antibody is a polyclonal antibody.

66. A method as in claim 61, wherein the prothrombin-deficient plasma is delipidized, comprising completely or partially removing lipoproteins.

67. The method as in claim 66, wherein the lipoproteins are removed using adsorption on lipophilic substances.

68. A method as in claim 61, wherein the prothrombin-deficient plasma is defibrinated, comprising completely or partially removing the ability of fibrin to form clots in plasma.

69. The method as in claim 68, wherein the removal of the ability of fibrin to form clots is accomplished by adding clot inhibitors, which are inhibitors of fibrin aggregation or polymerization.

70. The method as in claim 69, wherein the clot inhibitor is a peptide amide.

71. The method as in claim 68, wherein the removal of the ability of fibrin to form clots is accomplished by removing fibrin from the plasma.

72. The method as in claim 71, wherein the fibrin is removed by heat denaturation.

73. The method as in claim 71, wherein the fibrin is removed by precipitation.

74. The method as in claim 71, wherein the fibrin is removed by immunoaffinity chromatography.

75. The method as in claim 71, wherein the fibrin is removed by treatment with snake venom.

76. The method as in claim 75, wherein the snake venom is from Bothrops atrox.

77. A method of using plasma products for calibrating, standardizing, and controlling thrombin-related tests in which the prothrombin activity or thrombin concentration is determined by activation of prothrombin.

78. The method as in claim 77, wherein the thrombin-related tests are a thrombin activity test, a thrombin generation test, a prothrombin test, or an enzymatic test.

79. The method as in claim 78, wherein the thrombin activity test is an endogenous thrombin potential test (ETP).
